(19) United States
(12) Patent Application Publication
(10) Pub. No.: US 2025/0046512 A1
(43) Pub. Date: Feb. 6, 2025

(54) INTEGRATED TRANSFORMER-INDUCTOR AND EMI SHIELD

(71) Applicant: VIRGINIA TECH INTELLECTUAL PROPERTIES, INC., Blacksburg, VA (US)

(72) Inventors: Ahmed Nabih, Blacksburg, VA (US); Feng Jin, Blacksburg, VA (US); Qiang Li, Blacksburg, VA (US)

(21) Appl. No.: 18/362,222

(22) Filed: Jul. 31, 2023

Related U.S. Application Data
(60) Provisional application No. 63/481,728, filed on Jan. 26, 2023.

(51) Int. Cl. H01F 27/28; H01F 27/26; H02M 1/00; H02M 3/335

(52) U.S. Cl. CPC H01F 27/288; H01F 27/26; H02M 1/0058; H02M 3/33576

(57) ABSTRACT

Power converters with integrated transformers and resonant inductors are described. An example power converter includes a primary-side converter stage, a number of secondary-side converter stages, and an integrated transformer and resonant inductor coupled between the primary-side and secondary-side converter stages. The integrated transformer includes a magnetic core having a first leg, an auxiliary leg, and a second leg. The integrated transformer also includes a first transformer having a first primary winding, a first secondary winding, and a first shield winding on the first leg, and a second transformer having a second primary winding, a second secondary winding, and a second shield winding on the second leg. The first shield winding is electrically coupled to provide an extension of the first primary winding for the first transformer, and an end of the first shield winding or the second shield winding is electrically coupled to a primary-side ground of the power converter.

### BACKGROUND

Many electronic devices and systems rely upon power at a well-regulated, constant, and well-defined voltage for proper operation. In that context, power conversion devices and systems are relied upon to convert electric power or energy from one form to another. A power converter is an electrical or electro-mechanical device or system for converting electric power or energy from one form to another. As examples, power converters can convert alternating current (AC) power into direct current (DC) power, convert DC power to AC power, provide a DC to DC conversion, provide an AC to AC conversion, change or vary the characteristics (e.g., the voltage rating, current rating, frequency, etc.) of power, or offer other forms of power conversion. A power converter can be as simple as a transformer, but many power converters have more complicated designs and are tailored for a variety of applications and operating specifications.

Many applications rely upon high-efficiency DC-DC converters that provide isolation to the load. Although many topologies are good candidates for this application, resonant converters can be desirable due to their ability to achieve soft-switching for the primary and secondary devices, thereby enabling the frequencies to be increased, resulting in higher power densities.

### SUMMARY

Power converters with integrated transformers and resonant inductors are described. An example power converter includes a primary-side converter stage, a number of secondary-side converter stages, and an integrated transformer and resonant inductor coupled between the primary-side and secondary-side converter stages. The integrated transformer includes a magnetic core having a first leg, an auxiliary leg, and a second leg. The integrated transformer also includes a first transformer having a first primary winding, a first secondary winding, and a first shield winding on the first leg, and a second transformer having a second primary winding, a second secondary winding, and a second shield winding on the second leg. The first shield winding is electrically coupled to provide an extension of the first primary winding for the first transformer, and an end of the first shield winding or the second shield winding is electrically coupled to a primary-side ground of the power converter.

In other aspects, the first shield winding and the second shield winding are electrically coupled in series at a center node between the first shield winding and the second shield winding. The first shield winding and the second shield winding are electrically coupled to the primary-side ground of the power converter at the center node between the first shield winding and the second shield winding in one example. In another example, the first shield winding and the second shield winding are electrically coupled to the primary-side ground of the power converter at one end of the second shield winding apart from the center node between the first shield winding and the second shield winding.

In other aspects, the first primary winding and the second primary winding are electrically coupled in series at a center node between the first shield winding and the second shield winding. One end of the second primary winding is electrically coupled in series with the first primary winding, and another end of the second primary winding is electrically coupled to one end of the first shield winding apart from the center node between the first shield winding and the second shield winding.

In other aspects, the first primary winding and the second primary winding are electrically coupled in series at a center node between the first shield winding and the second shield winding. One end of the second primary winding is electrically coupled in series with the first primary winding. Another end of the second primary winding is electrically coupled to one end of the first shield winding apart from the center node between the first shield winding and the second shield winding, and the first shield winding and the second shield winding are electrically coupled to the primary-side ground of the power converter at the center node between the first shield winding and the second shield winding.

In some examples, the magnetic core further includes a left auxiliary leg and right auxiliary leg for distribution of leakage flux and reduced core loss in the magnetic core. In other examples, a first turns ratio between the first primary winding to the first secondary winding is different than a second turns ratio between the second primary winding to the second secondary winding.

### BRIEF DESCRIPTION OF THE DRAWINGS

Many aspects of the present disclosure can be better understood with reference to the following drawings. The components in the drawings are not necessarily to scale, with emphasis instead being placed upon clearly illustrating the principles of the disclosure. Moreover, in the drawings, like reference numerals designate corresponding parts throughout the several views.

FIG. 1 illustrates an example power converter according to various aspects of the present disclosure.

FIG. 2 illustrates an example integrated transformer used in the power converter shown in FIG. 1 according to various aspects of the present disclosure.

FIG. 3 illustrates an example power converter according to various aspects of the present disclosure.

FIG. 4 illustrates an example integrated transformer used in the power converter shown in FIG. 3 according to various aspects of the present disclosure.

FIG. 5A illustrates a schematic diagram of another example integrated transformer according to various aspects of the present disclosure.

FIG. 5B illustrates an example winding layout for the integrated transformer shown in FIG. 5A according to various aspects of the present disclosure.

FIG. 6A illustrates a schematic diagram of another example integrated transformer according to various aspects of the present disclosure.

FIG. 6B illustrates an example winding layout for the integrated transformer shown in FIG. 6A according to various aspects of the present disclosure.

FIG. 7 illustrates an example integrated transformer according to various aspects of the present disclosure.

FIG. 8 illustrates other example profiles of core legs according to various aspects of the present disclosure.

FIG. 9 illustrates another example magnetic core component according to various aspects of the present disclosure.

FIG. 10A illustrates another example integrated transformer according to various aspects of the present disclosure.

FIG. 10B illustrates another example integrated transformer according to various aspects of the present disclosure.

FIG. 11A illustrates another example integrated transformer including additional series-connected transformer legs according to various aspects of the present disclosure.

FIG. 11B illustrates an example magnetic core component for the integrated transformer shown in FIG. 11A according to various aspects of the present disclosure.

FIG. 12A illustrates another example integrated transformer including parallelized transformer legs according to various aspects of the present disclosure.

FIG. 12B illustrates an example magnetic core component for the integrated transformer shown in FIG. 12A according to various aspects of the present disclosure.

FIG. 13 illustrates another example integrated transformer including parallelized transformer legs according to various aspects of the present disclosure.

### DETAILED DESCRIPTION

Power conversion devices and systems are relied upon to convert electric power or energy from one form to another. A power converter is an electrical or electro-mechanical device or system for converting electric power or energy from one form to another. As examples, power converters can convert alternating current (AC) power into direct current (DC) power, convert DC power to AC power, provide a DC to DC conversion, provide an AC to AC conversion, change or vary the characteristics (e.g., the voltage rating, current rating, frequency, etc.) of power, or offer other forms of power conversion. A power converter can be as simple as a transformer, but many power converters have more complicated designs and are tailored for a variety of applications and operating specifications.

High performance Application Specific Integrated Circuits (ASICs), including a range of different types of Central Processing Units (CPUs) and Graphics Processing Units (GPUs), can consume a significant amount of power at relatively low voltage and high current specifications. In datacenter applications, a number of different types of power converters can be relied upon to convert multi-phase AC power to DC power at a voltage suitable for use by motherboards, CPUs, GPUs, and other components. For example, a first type of power converter can be relied upon to convert AC power to DC power at an output voltage of about 400 volts (V). A second type of power converter can be relied upon to convert the DC power at 400 V to DC power at about 48 V, and a third type of power converter can be relied upon to convert the DC power at about 48 V to DC power at about 12 V. Additional power converters, sometimes implemented on motherboards or on system on card (SoC) boards can convert the DC power at about 12 V to power at voltages between about 0.8-1.8 V.

A range of isolated and non-isolated power converters are known. Examples of non-isolated power converters include buck, books, buck-boost, and Ćuk power converters. A buck or step-down converter is one example of a non-isolated DC-to-DC power converter that could be relied upon for the conversion of power at a higher DC voltage at a lower current rating to a lower DC voltage at a higher current rating. As a switching converter, a buck converter can provide better power efficiency than linear regulators. The efficiency of buck converters can be relatively high, making buck converters a good choice for DC-to-DC power conversion applications used in computers and computing systems.

Resonant DC-to-DC power converters are good candidates for converting power at about 400 V to about 40-60 V, due to their ability to achieve soft-switching for the primary and secondary converter stages, enabling the use of higher frequencies and higher power densities. A range of different integrated magnetic devices, such as integrated transformers, have been used for interfacing the primary and secondary converter stages in DC-to-DC power converters. Some integrated transformers are designed to provide a series inductance for use in the resonant tank of resonant DC-to-DC power converters. This series inductance, which can be formed from the leakage inductance of an integrated transformer, can be relied upon as the resonant inductor in the resonant tank, avoiding the need for a separate resonant inductor.

A number of different topologies for resonant DC-to-DC power converters are known. Some DC-to-DC power converters include parallelized secondary converter stages for applications demanding higher levels of current. A range of concerns arise in the design of integrated transformers for power converters having parallelized secondary converter stages.

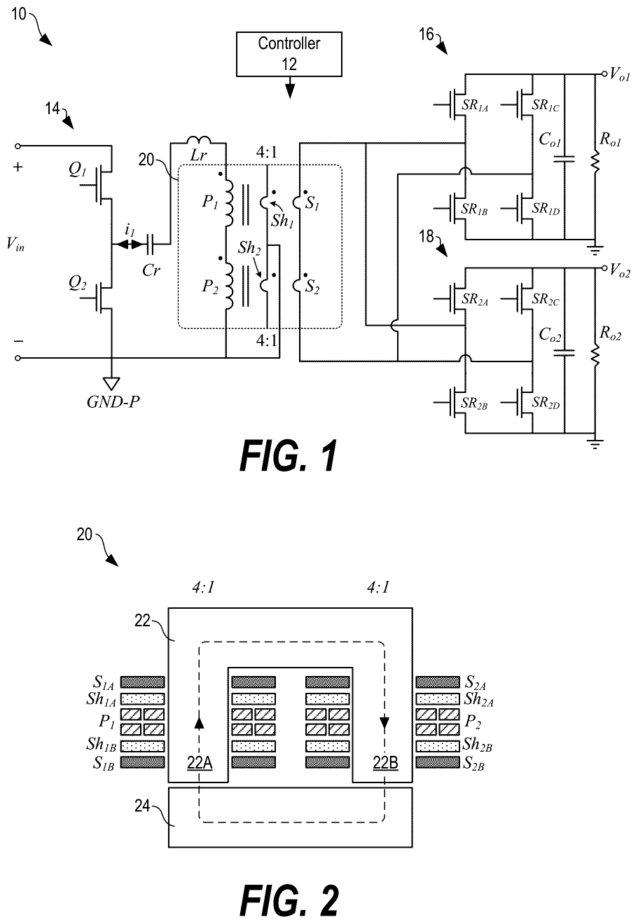

FIG. 1 illustrates an example power converter 10 according to various aspects of the present disclosure. The power converter 10 is illustrated as a representative example of a resonant DC-to-DC power converter. In some cases, the power converter 10 can include other components that are not illustrated in FIG. 1, such as additional output converter stages, capacitors, inductors, diodes or switching transistors, and other components. The power converter 10 can be implemented using a combination of integrated and discrete circuit components, for example, on one or more printed circuit boards (PCBs). The concepts of integrated transformers with resonant inductors and electromagnetic interference (EMI) shields, as described herein, can be applied in the power converter 10, as one example, among other types of power converters.

The power converter 10 includes a controller 12, a primary-side converter stage 14, two secondary-side converter stages 16 and 18, and an integrated transformer and resonant inductor 20 (also “integrated transformer 20”) that is electrically coupled between the primary-side converter stage 14 and the secondary-side converter stages 16 and 18. An input voltage Vᵢₙ is applied as an input to the power converter 10, and output voltages Vₒ₁ and Vₒ₂ are generated at an output of the power converter 10. The input voltage Vᵢₙ can be 400 V and the output voltages Vₒ₁ and Vₒ₂ can be 48 V in one example, although the power converter 10 can operate with a relatively wide range of input voltages (e.g., 300 V to 500 V) and output voltages (e.g., 40 V to 60 V) based on the control provided by the controller 12. The power converter 10 is not limited to use with any particular range of voltages, however, and the integrated transformer concepts described herein can be applied to power converters operating over a range of input and output voltages and power levels.

The primary-side converter stage 14 includes a half bridge arrangement of switching devices Q₁ and Q₂ and a resonant tank including a resonant capacitor Cᵣ and a resonant inductor Lᵣ. The switching devices Q₁ and Q₂ can be embodied as switching transistors, such as insulated-gate bipolar transistors or other suitable transistors. The switching devices Q₁ and Q₂ can be embodied in wide band gap (WBG) semiconductor materials, such as gallium nitride (GaN) and silicon carbide (SiC), semiconductor materials, as examples, including GaN/SiC power modules. The switching devices Q₁ and Q₂ are not limited to any particular type of switching device or devices formed from any particular type of semiconductor materials, however. The operation of the switching devices Q₁ and Q₂ (e.g., the flow of current through the switching devices Q₁ and Q₂) can be controlled by gate drive control signals provided by the controller 12, as described below. The primary-side converter stage 14 is illustrated to include a half bridge arrangement of switching devices in FIG. 1, but the use of full bridge and other arrangements of switching devices can also be relied upon in the primary-side converter stage 14. The primary-side converter stage 14 is electrically coupled to the primary side and primary windings of the integrated transformer 20.

The secondary-side converter stage 16 includes a full bridge arrangement of synchronous rectifiers SR_{1A}-SR_{1D}, an output capacitor Cₒ₁, and an output resistor R₀₁, which may be representative of a load applied to the secondary-side converter stage 16. The synchronous rectifiers SR_{1A}-SR_{1D} can be embodied as the MOSFET-based synchronous rectifiers, for example, although other types of active devices can be relied upon for the synchronous rectifiers SR_{1A}-SR_{1D}. The operation of the synchronous rectifiers SR_{1A}-SR_{1D} (e.g., the flow of current through the synchronous rectifiers SR_{1A}-SR_{1D}) can be controlled by drive control signals provided by the controller 12, as described below. The secondary-side converter stage 16 is electrically coupled to the secondary side and secondary windings of the integrated transformer 20.

The secondary-side converter stage 18 includes a full bridge arrangement of synchronous rectifiers SR_{2A}—SR_{2D}, an output capacitor Cₒ₂, and an output resistor R₀₂, which may be representative of a load applied to the secondary-side converter stage 18. The synchronous rectifiers SR_{2A}-SR_{2D} can be embodied as the MOSFET-based synchronous rectifiers, for example, although other types of active devices can be relied upon for the synchronous rectifiers SR_{2A}-SR_{2D}. The operation of the synchronous rectifiers SR_{2A}-SR_{2D} (e.g., the flow of current through the synchronous rectifiers SR_{2A}-SR_{2D}) can be controlled by drive control signals provided by the controller 12, as described below. The secondary-side converter stage 18 is electrically coupled to the secondary side and secondary windings of the integrated transformer 20. The secondary-side converter stages 16 and 18 is electrically coupled in parallel to the secondary side and secondary windings of the integrated transformer 20. The outputs Vₒ₁ and Vₒ₂ of the secondary-side converter stages 16 and 18 can feed additional power converter stages, respectively, or the outputs Vₒ₁ and Vₒ₂ can be parallelized in some cases for applications demanding higher levels of current.

The controller 12 is configured to generate gate control signals to control the operation of the switching devices Q₁ and Q₂ at an operating frequency of the power converter 10, which can range among the embodiments. Example operating frequencies for the power converter 10 can range from tens of kHz to several MHz or higher. As one example, the switching devices Q₁ and Q₂ can be operated by pulse width modulation (PWM) control signals generated by the controller 12. Based on the switching control, the switching devices Q₁ and Q₂ can be opened and closed, alternately, to charge the resonant tank of the primary-side converter stage 14 through supply of the current i₁ using the input voltage Vᵢₙ during one phase of a switching cycle and to discharge the resonant tank to the GND-P primary-side ground of the power converter 10 during another phase of the switching cycle. The charge and discharge of the resonant tank of the primary-side converter stage 14 also charges and discharges the primary side and primary windings of the integrated transformer 20.

The controller 12 is also configured to generate drive control signals to control the operation of the synchronous rectifiers SR_{1A}-SR_{1D} in the secondary-side converter stage 16 and to control the operation of the synchronous rectifiers SR_{2A}-SR_{2D} in the secondary-side converter stage 18. As one example, the synchronous rectifiers SR_{1A}-SR_{1D} and SR_{2A}-SR_{2D} can be operated by PWM control signals generated by the controller 12. Based on the drive control signals, the synchronous rectifiers SR_{1A}-SR_{1D} and SR_{2A}-SR_{2D} can be controlled to pass or cut off the flow of current, alternately, to charge the output capacitors Cₒ₁ and Cₒ₂.

The integrated transformer 20 includes a magnetic core, primary windings P₁ and P₂, shield windings Sh₁ and Sh₂, and secondary windings S₁ and S₂. The integrated transformer 20 provides two transformers in the power converter 10, including a first transformer between the primary-side converter stage 14 and the secondary-side converter stages 16 and 18 and a second transformer between the primary-side converter stage 14 and the secondary-side converter stages 16 and 18. The first transformer is formed from the primary winding P₁ and the secondary winding S₁, with the shield winding Sh₁ positioned between them. The second transformer is formed from the primary winding P₂ and the secondary winding S₂, with the shield winding Sh₂ positioned between them. The first transformer is a 4:1 transformer in the example shown in FIG. 1, with the primary winding P₁ including four turns and the secondary winding S₁ including a single turn. The second transformer is also a 4:1 transformer, with the primary winding P₂ including four turns and the secondary winding S₂ including a single turn. However, the integrated transformers described herein are not limited to any particular turns ratios between the primary and secondary sides, and other integrated transformers with other turns ratios are described herein.

In the example shown in FIG. 1, the primary winding P₁ is coupled in series with the primary winding P₂ between the resonant tank of the primary-side converter stage 14 and the GND-P primary-side ground of the power converter 10. The secondary winding S₁ is also coupled in series with the secondary winding S₂. One end of the secondary winding S₁ is electrically coupled between the synchronous rectifiers SR_{1A} and SR_{1B} of the secondary-side converter stage 16 and is also electrically coupled between the synchronous rectifiers SR_{2A} and SR_{2B} of the secondary-side converter stage 18. Another end of the secondary winding S₁ is electrically coupled to one end of the secondary winding S₂. Another end of the secondary winding S₂ is electrically coupled between the synchronous rectifiers SR_{1C} and SR_{1D} of the secondary-side converter stage 16 and is also electrically coupled between the synchronous rectifiers SR_{2C} and SR_{2D} of the secondary-side converter stage 18.

The shield windings Sh₁ and Sh₂ are electrically coupled together at one end, and the shield windings Sh₁ and Sh₂ are electrically coupled to the GND-P primary-side ground of the power converter 10. The shield windings Sh₁ and Sh₂ provide shielding between the primary windings P₁ and P₂ and the secondary windings S₁ and S₂ in the integrated transformer 20. More particularly, the shield windings Sh₁ and Sh₂ provide common mode shielding and reduce the transfer of common mode noise from the primary to the secondary side of the integrated transformer 20. An example of the arrangement and placement of the windings with the magnetic core in the integrated transformer 20 is described below with reference to FIG. 2.

FIG. 2 illustrates an example of the integrated transformer 20 used in the power converter 10 shown in FIG. 1. The integrated transformer 20 includes a magnetic “CI” core with a “C” core component 22 and an “I” core component 24. In other examples, the integrated transformer 20 can be embodied with a “CC” core or other types of cores. The magnetic core of the integrated transformer 20 can be embodied as a material of high magnetic permeability, such as a ferromagnetic material like iron, laminated silicon steel, laminated iron sheets, or other solid or laminated ferromagnetic ceramic, metal, metal alloy, or related material(s). The “C” core component 22 includes a first leg 22A and a second leg 22B. The integrated transformer 20 provides a first 4:1 transformer on the first leg 22A and a second 4:1 transformer on the second leg 22B. The first and second transformers are magnetically coupled together by the magnetic “CI” core, and magnetic flux passes through the magnetic “CI” core.

The primary winding P₁, the shield winding Sh₁, and the secondary winding S₁ extend or wind around the first leg 22A, and the primary winding P₂, the shield winding Sh₂, and the secondary winding S₂ extend or wind around the second leg 22B. In one example, the primary windings P₁ and P₂, shield windings Sh₁ and Sh₂, and secondary windings S₁ and S₂ of the integrated transformer 20 can be embodied as a stack of metal layers in a PCB, including through-PCB vias and metal traces to electrically couple the windings together in the PCB as needed. The PCB can include any number of metal layers in the stack, as needed, to implement the number of windings and turns described herein, along with dielectric insulating materials among them in a laminated structure.

In the example shown in FIG. 2, the primary winding P₁ includes four turns around the first leg 22A. The primary winding P₁ can be implemented in a variety of ways in the stack of metal layers of the PCB. For example, the primary winding P₁ can be implemented as a first metal layer including two turns around the first leg 22A and a second metal layer including another two turns around the first leg 22A, with one or more vias electrically coupling them. As another example, the primary winding P₁ can be implemented four separate metal layers each including a single turn around the first leg 22A. The primary winding P₂ can also be implemented in a variety of ways. For example, the primary winding P₂ can be implemented as a first metal layer including two turns around the second leg 22B and a second metal layer including another two turns around the second leg 22B, with one or more vias electrically coupling them. As another example, the primary winding P₂ can be implemented four separate metal layers each including a single turn around the second leg 22B. Other options for implementing the primary windings P₁ and P₂ are described below and are within the scope of the embodiments. The primary windings P₁ and P₂ are positioned at a center of the stack in the example shown in FIG. 2, with the shield windings Sh₁ and Sh₂ and the secondary windings S₁ and S₂ of the integrated transformer 20 being positioned above and below the primary windings P₁ and P₂.

The secondary winding S₁ includes a single turn around the first leg 22A. The secondary winding S₁ is formed as two separated layers in the stack, including the secondary winding layer S_{1A} and the secondary winding layer S_{1B}. The secondary winding layer S_{1A} is positioned at a top of the stack, and the secondary winding layer S_{1B} is positioned at a bottom of the stack in the example shown. The secondary winding layers S_{1A} and S_{1B} are electrically coupled together in parallel form a single, double-layer turn around the first leg 22A. The secondary winding S₂ includes a single turn around the second leg 22B. The secondary winding S₂ is formed as two separated layers in the stack, including the secondary winding layer S_{2A} and the secondary winding layer S_{2B}. The secondary winding layer S_{2A} is positioned at a top of the stack, and the secondary winding layer S_{2B} is positioned at a bottom of the stack in the example shown. The secondary winding layers S_{2A} and S_{2B} are electrically coupled together in parallel form a single, double-layer turn around the second leg 22B.

The shield winding Sh₁ includes a single turn around the first leg 22A. The shield winding Sh₁ is formed as two separated layers in the stack, including the shield layer Shia and the shield layer Sh_{1B}. The shield layer Shia is positioned over or above the primary winding P₁ in the stack, and the shield layer Sh_{1B} is positioned under or below the primary winding P₁ in the stack. The shield layers Sh_{1A} and Sh_{1B} are electrically coupled together in parallel form a single, double-layer turn around the first leg 22A. The shield winding Sh₂ includes a single turn around the second leg 22B. The shield winding Sh₂ is formed as two separated layers in the stack, including the shield layer Sh_{2A} and the shield layer Sh_{2B}. The shield layer Sh_{2A} is positioned over or above the primary winding P₂ in the stack, and the shield layer Sh_{2B} is positioned under or below the primary winding P₂ in the stack. The shield layers Sh_{2A} and Sh_{2B} are electrically coupled together in parallel form a single, double-layer turn around the second leg 22B.

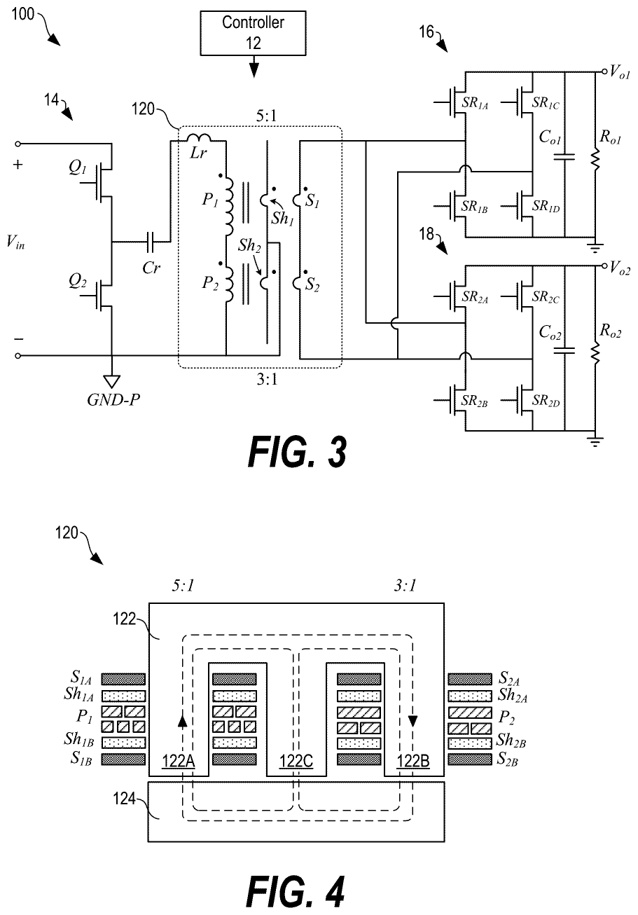

FIG. 3 illustrates an example power converter 100 according to various aspects of the present disclosure. The power converter 100 is illustrated as a representative example of a resonant DC-to-DC power converter. In some cases, the power converter 100 can include other components that are not illustrated in FIG. 3, such as additional output converter stages, capacitors, inductors, diodes or switching transistors, and other components. The power converter 100 can be implemented using a combination of integrated and discrete circuit components, for example, on one or more PCBs. The concepts of integrated transformers with resonant inductors and EMI shields, as described herein, can be applied in the power converter 100.

Similar to the power converter 10 shown in FIG. 1, the power converter 100 includes a controller 12, a primary-side converter stage 14, and two secondary-side converter stages 16 and 18. The power converter 100 also includes an integrated transformer and resonant inductor 120 (also “integrated transformer 120”) that is electrically coupled between the primary-side converter stage 14 and the secondary-side converter stages 16 and 18. An input voltage Vᵢₙ is applied as an input to the power converter 100, and output voltages Vₒ₁ and Vₒ₂ are generated at an output of the power converter 100.

The integrated transformer 120 in the power converter 100 has a different structure than the integrated transformer 20 in the power converter 10. Based on the design of the integrated transformer 120, it incorporates a series inductance for use in the resonant tank of the power converter 100. Particularly, the integrated transformer 120 incorporates the resonant inductor Lᵣ. Thus, as opposed to the power converter 10 shown in FIG. 1, which relies upon a separate inductor component for the resonant inductor Lᵣ, the power converter 100 does not have a separate component for the resonant inductor Lᵣ. The resonant inductor Lᵣ is implemented as part of the integrated transformer 120 in the power converter 100.

The integrated transformer 120 includes a magnetic core, primary windings P₁ and P₂, shield windings Sh₁ and S₂, and secondary windings S₁ and S₂. The integrated transformer 120 provides two transformers in the power converter 100, including a first transformer between the primary-side converter stage 14 and the secondary-side converter stages 16 and 18 and a second transformer between the primary-side converter stage 14 and the secondary-side converter stages 16 and 18. The first transformer is formed from the primary winding P₁ and the secondary winding S₁, with the shield winding Sh₁ positioned between them. The second transformer is formed from the primary winding P₂ and the secondary winding S₂, with the shield winding Sh₂ positioned between them. The first transformer is a 5:1 transformer in the example shown in FIG. 1, with the primary winding P₁ including five turns and the secondary winding S₁ including a single turn. The second transformer is a 3:1 transformer, with the primary winding P₂ including three turns and the secondary winding S₂ including a single turn. However, the integrated transformers described herein are not limited to any particular turns ratios between the primary and secondary sides, and other integrated transformers with other turns ratios are described herein.

In the example shown in FIG. 2, the primary winding P₁ is coupled in series with the primary winding P₂ between the primary-side converter stage 14 and the GND-P primary-side ground of the power converter 100. The secondary winding S₁ is also coupled in series with the secondary winding S₂. One end of the secondary winding S₁ is electrically coupled between the synchronous rectifiers SR_{1A} and SR_{1B} of the secondary-side converter stage 16 and is also electrically coupled between the synchronous rectifiers SR_{2A} and SR_{2B} of the secondary-side converter stage 18. Another end of the secondary winding S₁ is electrically coupled to one end of the secondary winding S₂. Another end of the secondary winding S₂ is electrically coupled between the synchronous rectifiers SR_{1C} and SR_{1D} of the secondary-side converter stage 16 and is also electrically coupled between the synchronous rectifiers SR_{2C} and SR_{2D} of the secondary-side converter stage 18.

The shield windings Sh₁ and Sh₂ are electrically coupled together at one end, and the shield windings Sh₁ and Sh₂ are electrically coupled to the GND-P primary-side ground of the power converter 100. The shield windings Sh₁ and Sh₂ provide shielding between the primary windings P₁ and P₂ and the secondary windings S₁ and S₂ in the integrated transformer 120. More particularly, the shield windings Sh₁ and Sh₂ provide common mode shielding and reduce the transfer of common mode noise from the primary to the secondary side of the integrated transformer 120. An example of the arrangement and placement of the windings with the magnetic core in the integrated transformer 20 is described below with reference to FIG. 4.

FIG. 4 illustrates an example of the integrated transformer 120 used in the power converter 100 shown in FIG. 3. The integrated transformer 120 includes a magnetic “EI” core with a “E” core component 122 and an “I” core component 124. In other examples, the integrated transformer 120 can be embodied with an “EE” core or other types of cores. The magnetic core of the integrated transformer 120 can be embodied as a material of high magnetic permeability, such as a ferromagnetic material like iron, laminated silicon steel, laminated iron sheets, or other solid or laminated ferromagnetic ceramic, metal, metal alloy, or related material(s). The “E” core component 122 includes a first leg 122A, a second leg 122B, and an auxiliary leg 122C between the first leg 122A and the second leg 122B. The integrated transformer 120 provides a first 5:1 transformer on the first leg 122A and a second 3:1 transformer on the second leg 122B. The first and second transformers are magnetically coupled together by the magnetic “EI” core, and magnetic flux passes through the magnetic “EI” core, as described below.

The primary winding P₁, the shield winding Sh₁, and the secondary winding S₁ extend or wind around the first leg 122A, and the primary winding P₂, the shield winding Sh₂, and the secondary winding S₂ extend or wind around the second leg 122B. In one example, the primary windings P₁ and P₂, shield windings Sh₁ and Sh₂, and secondary windings S₁ and S₂ of the integrated transformer 120 can be embodied as a stack of metal layers in a PCB, including through-PCB vias and metal traces to electrically couple the windings together in the PCB as needed. The PCB can include any number of metal layers in the stack, as needed, to implement the number of windings and turns described herein, along with dielectric insulating materials among them in a laminated structure. In other examples, the windings of the integrated transformer 120 can be implemented using wires (e.g., solid or stranded magnet wire, Litz wire, etc.), copper bars or layers, or in other ways.

In the example shown in FIG. 4, the primary winding P₁ includes five turns around the first leg 122A. The primary winding P₁ can be implemented in a variety of ways in the stack of metal layers of the PCB. For example, the primary winding P₁ can be implemented as a first metal layer including two turns around the first leg 122A and a second metal layer including another three turns around the first leg 122A, with one or more vias electrically coupling them. The primary winding P₂ can also be implemented in a variety of ways. For example, the primary winding P₂ can be implemented as a first metal layer including two turns around the second leg 122B and a second metal layer including one turn around the second leg 122B, with one or more vias electrically coupling them. Other options for implementing the primary windings P₁ and P₂ are within the scope of the embodiments. The primary windings P₁ and P₂ are positioned at a center of the stack in the example shown in FIG. 4, with the shield windings Sh₁ and Sh₂ and the secondary windings S₁ and S₂ of the integrated transformer 120 being positioned above and below the primary windings P₁ and P₂.

The secondary winding S₁ includes a single turn around the first leg 122A. The secondary winding S₁ is formed as two separated layers in the stack, including the secondary winding layer S_{1A} and the secondary winding layer S_{1B}. The secondary winding layer S_{1A} is positioned at a top of the stack, and the secondary winding layer S_{1B} is positioned at a bottom of the stack in the example shown. The secondary winding layers S_{1A} and S_{1B} are electrically coupled together in parallel form a single, double-layer turn around the first leg 122A. The secondary winding S₂ includes a single turn around the second leg 122B. The secondary winding S₂ is formed as two separated layers in the stack, including the secondary winding layer S_{2A} and the secondary winding layer S_{2B}. The secondary winding layer S_{2A} is positioned at a top of the stack, and the secondary winding layer S_{2B} is positioned at a bottom of the stack in the example shown. The secondary winding layers S_{2A} and S_{2B} are electrically coupled together in parallel form a single, double-layer turn around the second leg 122B.

The shield winding Sh₁ includes a single turn around the first leg 122A. The shield winding Sh₁ is formed as two separated layers in the stack, including the shield layer Sh_{1A} and the shield layer Sh_{1B}. The shield layer Sh_{1A} is positioned over or above the primary winding P₁ in the stack, and the shield layer Sh_{1B} is positioned under or below the primary winding P₁ in the stack. The shield layers Sh_{1A} and Ship are electrically coupled together in parallel form a single, double-layer turn around the first leg 122A. The shield winding Sh₂ includes a single turn around the second leg 122B. The shield winding Sh₂ is formed as two separated layers in the stack, including the shield layer Sh_{2A} and the shield layer Sh_{2B}. The shield layer Sh_{2A} is positioned over or above the primary winding P₂ in the stack, and the shield layer Sh_{2B} is positioned under or below the primary winding P₂ in the stack. The shield layers Sh_{2A} and Sh_{2B} are electrically coupled together in parallel form a single, double-layer turn around the second leg 122B.

Mutual magnetic flux passes through the first and second legs 122A and 122B of the magnetic “EI” core in the integrated transformer 120. Leakage flux passes through the auxiliary leg 122C of the magnetic “EI” core. Based on the unbalanced nature of the windings around the first leg 122A as compared to the second leg 122B and the leakage flux through the auxiliary leg 122C, the integrated transformer 120 exhibits a series inductance on the primary side of the integrated transformer 120. The series inductance is relied upon as the resonant inductor Lᵣ in the power converter 100. Thus, as opposed to the power converter 10 shown in FIG. 1, which relies upon a separate inductor component for the resonant inductor Lᵣ, the power converter 100 does not have a separate component for the resonant inductor Lᵣ. The resonant inductor Lᵣ is implemented as part of the integrated transformer 120 in the power converter 100.

However, the integrated transformer 120 exhibits more loss than (i.e., is less efficient than) the integrated transformer 20. The integrated transformer 120 exhibits increased core and winding loss as compared to the integrated transformer 20. The current density in at least some of the turns of the primary winding P₁ can be higher in the integrated transformer 120, particularly when implementing the integrated transformer 120 using the same number of metal layers and with the same footprint and volume as the integrated transformer 20. This increased current density can result in increased winding loss. Additionally, the integrated transformer 120 can suffer from increased core loss as compared to the integrated transformer 20, due to the relatively high concentration of leakage flux and corresponding core loss in the auxiliary leg 122C.

The embodiments described herein are directed to new arrangements and structures for integrated transformers with resonant inductors and EMI shields. The integrated transformers described herein rely upon the shield windings to effectively add and balance the turns of the primary windings in the integrated transformers. The integrated transformers exhibit increased efficiency, reduced winding loss, and reduced core loss as compared to other integrated transformers, such as the integrated transformer 120 shown in FIG. 4.

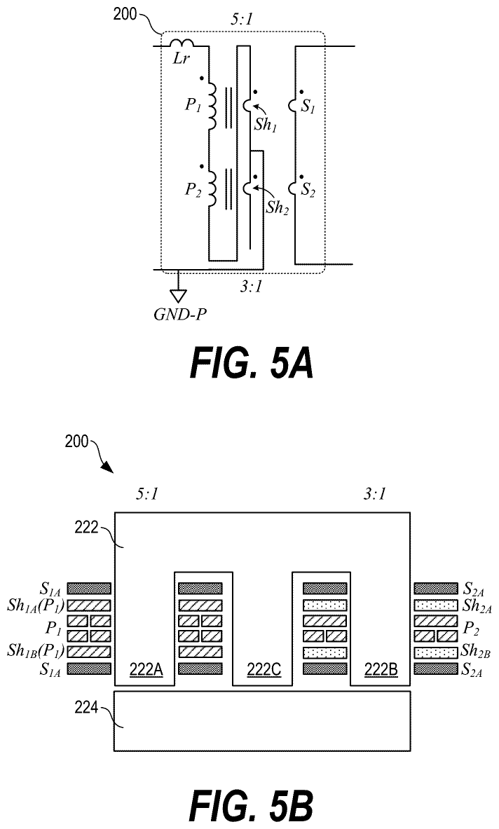

FIG. 5A illustrates a schematic diagram of another example integrated transformer 200 according to various aspects of the present disclosure, and FIG. 5B illustrates an example winding layout for the integrated transformer 200 shown in FIG. 5A. The integrated transformer 200 can be used in place of the integrated transformer 20 of the power converter 10 shown in FIG. 1, in place of the integrated transformer 120 of the power converter 100 shown in FIG. 3, or in other types of resonant power converters.

The integrated transformer 200 includes a magnetic core, primary windings P₁ and P₂, shield windings Sh₁ and S₂, and secondary windings S₁ and S₂. The integrated transformer 200 provides two transformers. The first transformer is formed from the primary winding P₁, the shield winding Sh₁, and the secondary winding S₁. The second transformer is formed from the primary winding P₂ and the secondary winding S₂, with the shield winding Sh₂ positioned between them.

As shown in FIG. 5A, the primary winding P₁ is coupled, at one end of the primary winding P₂, in series with the primary winding P₂. Rather than being coupled to the GND-P primary-side ground of a power converter (see, e.g., FIGS. 1 and 3), another end of the primary winding P₂ is coupled in series with one end of the shield winding Sh₁. The shield windings Sh₁ and Sh₂ are electrically coupled in series with each other. The shield windings Sh₁ and Sh₂ are electrically coupled to the GND-P primary-side ground of a power converter at a center node between the windings Sh₁ and Sh₂. The shield windings Sh₁ and Sh₂ provide shielding between the primary windings P₁ and P₂ and the secondary windings S₁ and S₂ in the integrated transformer 200. More particularly, the shield windings Sh₁ and Sh₂ provide common mode shielding and reduce the transfer of common mode noise from the primary to the secondary side of the integrated transformer 200.

The shield winding Sh₁ also serves an additional function (e.g., beyond shielding) in the integrated transformer 200. The shield winding Sh₁ serves as an additional or extension turn of the primary winding P₁. Thus, although the primary winding P₁ includes four turns, the first transformer is a 5:1 transformer in the example shown in FIG. 5A. Particularly, the primary winding P₁ includes four turns, the shield winding Sh₁ includes an additional or extension turn of the primary winding P₁, and the secondary winding S₁ including a single turn. The second transformer is a 3:1 transformer, with the primary winding P₂ including three turns and the secondary winding S₂ including a single turn.

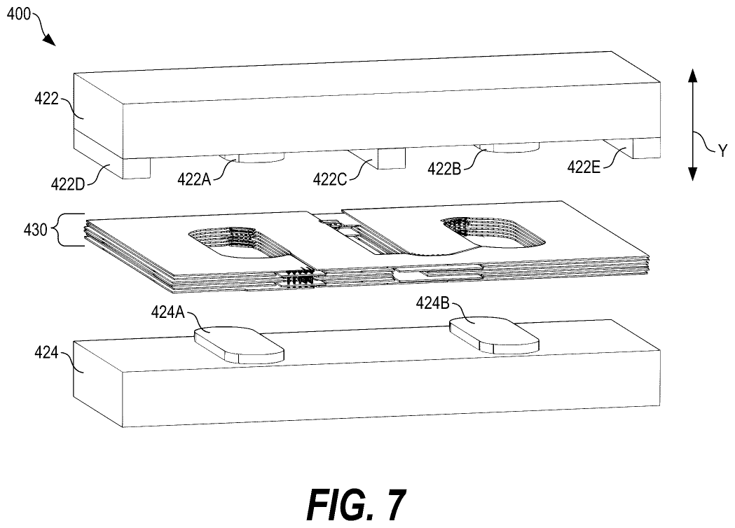

Turning to FIG. 5B, the integrated transformer 200 includes a magnetic “EI” core with a “E” core component 222 and an “I” core component 224. In other examples, the integrated transformer 200 can be embodied with an “EE” core or other types of cores. The magnetic core of the integrated transformer 200 can be embodied as a material of high magnetic permeability, such as a ferromagnetic material like iron, laminated silicon steel, laminated iron sheets, or other solid or laminated ferromagnetic ceramic, metal, metal alloy, or related material(s). The “E” core component 222 includes a first leg 222A, a second leg 222B, and an auxiliary leg 222C between the first leg 222A and the second leg 222B. The shapes and styles of the first leg 222A, the second leg 222B, and the auxiliary leg 222C can vary among the embodiments, as described below with reference to FIGS. 7-9. The integrated transformer 200 can also include additional auxiliary legs, as described below with reference to FIGS. 7-9.

The primary winding P₁, the shield winding Sh₁, and the secondary winding S₁ extend or wind around the first leg 222A, and the primary winding P₂, the shield winding Sh₂, and the secondary winding S₂ extend or wind around the second leg 222B. In one example, the primary windings P₁ and P₂, shield windings Sh₁ and Sh₂, and secondary windings S₁ and S₂ of the integrated transformer 200 can be embodied as a stack of metal layers in a PCB, including through-PCB vias and metal traces to electrically couple the windings together in the PCB as needed. The PCB can include any number of metal layers in the stack, as needed, to implement the number of windings and turns described herein, along with dielectric insulating materials among them in a laminated structure. In other examples, the windings of the integrated transformer 200 can be implemented using wires (e.g., solid or stranded magnet wire, Litz wire, etc.), copper bars or layers, or in other ways.

In the example shown in FIG. 5B, the primary winding P₁ includes four turns around the first leg 222A. The primary winding P₁ can be implemented in a variety of ways in the stack of metal layers of the PCB. For example, the primary winding P₁ can be implemented as a first metal layer including two turns around the first leg 222A and a second metal layer including another two turns around the first leg 222A, with one or more vias electrically coupling them. The primary winding P₂ can also be implemented in a variety of ways. For example, the primary winding P₂ can be implemented as a first metal layer including two turns around the second leg 222B and a second metal layer including one turn around the second leg 222B, with one or more vias electrically coupling them. Other options for implementing the primary windings P₁ and P₂ are within the scope of the embodiments. The primary windings P₁ and P₂ are positioned at a center of the stack in the example shown in FIG. 5B, with the shield windings Sh₁ and Sh₂ and the secondary windings S₁ and S₂ of the integrated transformer 200 being positioned above and below the primary windings P₁ and P₂.

The secondary winding S₁ includes a single turn around the first leg 222A. The secondary winding S₁ is formed as two separated layers in the stack, including the secondary winding layer S_{1A} and the secondary winding layer S_{1B}. The secondary winding layer S_{1A} is positioned at a top of the stack, and the secondary winding layer S_{1B} is positioned at a bottom of the stack in the example shown. The secondary winding layers S_{1A} and S_{1B} are electrically coupled together in parallel form a single, double-layer turn around the first leg 222A. The secondary winding S₂ includes a single turn around the second leg 222B. The secondary winding S₂ is formed as two separated layers in the stack, including the secondary winding layer S_{2A} and the secondary winding layer S_{2B}. The secondary winding layer S_{2A} is positioned at a top of the stack, and the secondary winding layer S_{2B} is positioned at a bottom of the stack in the example shown. The secondary winding layers S_{2A} and S_{2B} are electrically coupled together in parallel form a single, double-layer turn around the second leg 222B.

The shield winding Sh₁ includes a single turn around the first leg 222A. The shield winding Sh₁ is formed as two separated layers in the stack, including the shield layer Sh_{1A} and the shield layer Sh_{1B}. The shield layer Sh_{1A} is positioned over or above the primary winding P₁ in the stack, and the shield layer Sh_{1B} is positioned under or below the primary winding P₁ in the stack. The shield layers Sh_{1A} and Ship are electrically coupled together in parallel form a single, double-layer turn around the first leg 222A. As shown in the electrical schematic of FIG. 5A, the shield winding Sh₁ forms a final turn of the primary winding P₁. Thus, the shield layers Sh_{1A} and Sh_{1B} are denoted as Sh_{1A} (P₁) and Sh_{1B} (P₁) in FIG. 5B.

The shield winding Sh₂ includes a single turn around the second leg 222B. The shield winding Sh₂ is formed as two separated layers in the stack, including the shield layer Sh_{2A} and the shield layer Sh_{2B}. The shield layer Sh_{2A} is positioned over or above the primary winding P₂ in the stack, and the shield layer Sh_{2B} is positioned under or below the primary winding P₂ in the stack. The shield layers Sh_{2A} and Sh_{2B} are electrically coupled together in parallel form a single, double-layer turn around the second leg 222B.

Mutual magnetic flux passes through the first and second legs 222A and 222B of the magnetic “EI” core in the integrated transformer 200. Leakage flux passes through the auxiliary leg 222C of the magnetic “EI” core. Based on the unbalanced nature of the windings around the first leg 222A as compared to the second leg 222B and the leakage flux through the auxiliary leg 222C, the integrated transformer 200 exhibits a series inductance on the primary side of the integrated transformer 200. The series inductance can be relied upon as the resonant inductor Lᵣ.

The integrated transformer 200 shown in FIG. 5B exhibits less loss than (i.e., is more efficient than) the integrated transformer 120 shown in FIG. 4. The current density in the turns of the primary winding P₁ can be lower in the integrated transformer 200 than in the integrated transformer 120, particularly when implementing the integrated transformer 200 using the same number of metal layers and with the same footprint and volume as the integrated transformer 120. For example, the primary winding P₁ in the integrated transformer 200 can be implemented as two turns on each of two layers in a PCB, as shown in FIG. 5B. In the integrated transformer 120, on the other hand, one of the layers of the primary winding P₁ includes three turns (see FIG. 4), and the width of the traces for that layer of the primary winding P₁ are relatively more narrow, resulting in greater current density and winding loss particularly on the narrower traces.

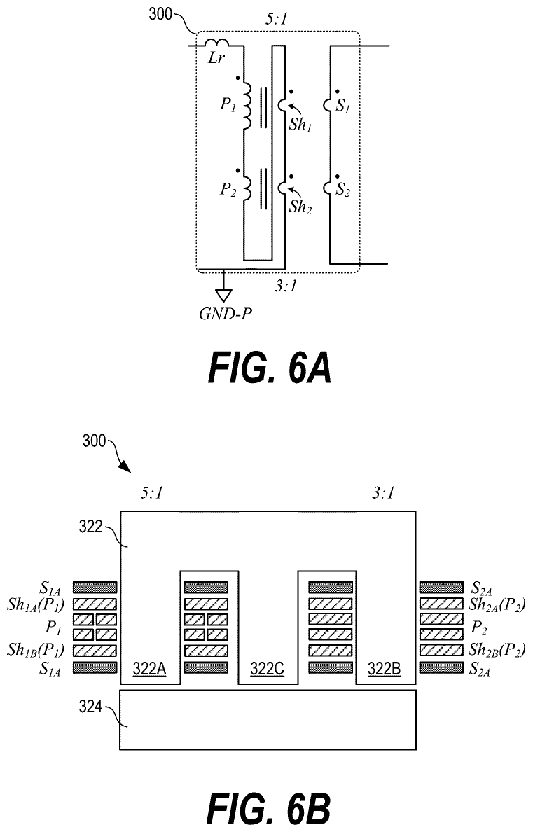

FIG. 6A illustrates a schematic diagram of another example integrated transformer 300 according to various aspects of the present disclosure, and FIG. 6B illustrates an example winding layout for the integrated transformer 300 shown in FIG. 6A. The integrated transformer 300 can be used in place of the integrated transformer 20 of the power converter 10 shown in FIG. 1, in place of the integrated transformer 120 of the power converter 101 shown in FIG. 3, or in other types of resonant power converters.

The integrated transformer 300 includes a magnetic core, primary windings P₁ and P₂, shield windings Sh₁ and S₂, and secondary windings S₁ and S₂. The integrated transformer 300 provides two transformers. The first transformer is formed from the primary winding P₁, the shield winding Sh₁, and the secondary winding S₁. The second transformer is formed from the primary winding P₂, the shield winding Sh₂, and the secondary winding S₂.

As shown in FIG. 6A, the primary winding P₁ is coupled, at one end of the primary winding P₂, in series with the primary winding P₂. Rather than being coupled to the GND-P primary-side ground of a power converter (see, e.g., FIGS. 1 and 3), another end of the primary winding P₂ is coupled in series with one end of the shield winding Sh₁. The shield windings Sh₁ and Sh₂ are electrically coupled in series with each other. The shield winding Sh₂ is electrically coupled to the GND-P primary-side ground of a power converter at one end of the shield winding Sh₂. The shield windings Sh₁ and Sh₂ provide shielding between the primary windings P₁ and P₂ and the secondary windings S₁ and S₂ in the integrated transformer 300. More particularly, the shield windings Sh₁ and Sh₂ provide common mode shielding and reduce the transfer of common mode noise from the primary to the secondary side of the integrated transformer 300.

The shield windings Sh₁ and Sh₂ also serve additional functions (e.g., beyond shielding) in the integrated transformer 300. The shield winding Sh₁ serves as an additional or extension turn of the primary winding P₁. Similarly, the shield winding Sh₂ serves as an additional or extension turn of the primary winding P₂. Thus, although the primary winding P₁ includes four turns, the first transformer is a 5:1 transformer in the example shown in FIG. 6A. Particularly, the primary winding P₁ includes four turns, the shield winding Sh₁ includes an additional or extension turn of the primary winding P₁, and the secondary winding S₁ including a single turn. Further, although the primary winding P₂ includes two turns, the second transformer is a 3:1 transformer in the example shown in FIG. 6A. Particularly, the primary winding P₂ includes two turns, the shield winding Sh₂ includes an additional or extension turn of the primary winding P₂, and the secondary winding S₂ including a single turn.

Turning to FIG. 6B, the integrated transformer 300 includes a magnetic “EI” core with a “E” core component 322 and an “I” core component 324. In other examples, the integrated transformer 300 can be embodied with an “EE” core or other types of cores. The magnetic core of the integrated transformer 300 can be embodied as a material of high magnetic permeability, such as a ferromagnetic material like iron, laminated silicon steel, laminated iron sheets, or other solid or laminated ferromagnetic ceramic, metal, metal alloy, or related material(s). The “E” core component 322 includes a first leg 322A, a second leg 322B, and an auxiliary leg 322C between the first leg 322A and the second leg 322B. The shapes and styles of the first leg 322A, the second leg 322B, and the auxiliary leg 322C can vary among the embodiments, as described below with reference to FIGS. 7-9. The integrated transformer 300 can also include additional auxiliary legs, as described below with reference to FIGS. 7-9.

The primary winding P₁, the shield winding Sh₁, and the secondary winding S₁ extend or wind around the first leg 322A, and the primary winding P₂, the shield winding Sh₂, and the secondary winding S₂ extend or wind around the second leg 322B. In one example, the primary windings P₁ and P₂, shield windings Sh₁ and Sh₂, and secondary windings S₁ and S₂ of the integrated transformer 300 can be embodied as a stack of metal layers in a PCB, including through-PCB vias and metal traces to electrically couple the windings together in the PCB as needed. The PCB can include any number of metal layers in the stack, as needed, to implement the number of windings and turns described herein, along with dielectric insulating materials among them in a laminated structure. In other examples, the windings of the integrated transformer 200 can be implemented using wires (e.g., solid or stranded magnet wire, Litz wire, etc.), copper bars or layers, or in other ways.

In the example shown in FIG. 6B, the primary winding P₁ includes three turns around the first leg 322A. The primary winding P₁ can be implemented in a variety of ways in the stack of metal layers of the PCB. For example, the primary winding P₁ can be implemented as a first metal layer including two turns around the first leg 322A and a second metal layer including another two turns around the first leg 322A, with one or more vias electrically coupling them. The primary winding P₂ can also be implemented in a variety of ways. For example, the primary winding P₂ can be implemented as a first metal layer including two turns around the first leg 322B and a second metal layer including one turn around the first leg 322B, with one or more vias electrically coupling them. Other options for implementing the primary windings P₁ and P₂ are within the scope of the embodiments. The primary windings P₁ and P₂ are positioned at a center of the stack in the example shown in FIG. 6B, with the shield windings Sh₁ and Sh₂ and the secondary windings S₁ and S₂ of the integrated transformer 300 being positioned above and below the primary windings P₁ and P₂.

The secondary winding S₁ includes a single turn around the first leg 322A. The secondary winding S₁ is formed as two separated layers in the stack, including the secondary winding layer S_{1A} and the secondary winding layer S_{1B}. The secondary winding layer S_{1A} is positioned at a top of the stack, and the secondary winding layer S_{1B} is positioned at a bottom of the stack in the example shown. The secondary winding layers S_{1A} and S_{1B} are electrically coupled together in parallel form a single, double-layer turn around the first leg 322A. The secondary winding S₂ includes a single turn around the second leg 322B. The secondary winding S₂ is formed as two separated layers in the stack, including the secondary winding layer S_{2A} and the secondary winding layer S_{2B}. The secondary winding layer S_{2A} is positioned at a top of the stack, and the secondary winding layer S_{2B} is positioned at a bottom of the stack in the example shown. The secondary winding layers S_{2A} and S_{2B} are electrically coupled together in parallel form a single, double-layer turn around the second leg 322B.

The shield winding Sh₁ includes a single turn around the first leg 322A. The shield winding Sh₁ is formed as two separated layers in the stack, including the shield layer Sh_{1A} and the shield layer Sh_{1B}. The shield layer Sh_{1A} is positioned over or above the primary winding P₁ in the stack, and the shield layer Sh_{1B} is positioned under or below the primary winding P₁ in the stack. The shield layers Sh_{1A} and Sh_{1B} are electrically coupled together in parallel form a single, double-layer turn around the first leg 322A. As shown in the electrical schematic of FIG. 6A, the shield winding Sh₁ forms a final turn of the primary winding P₁. Thus, the shield layers Sh_{1A} and Sh_{1B} are denoted as Sh_{1A} (P₁) and Sh_{1B} (P₁) in FIG. 6B.

The shield winding Sh₂ includes a single turn around the second leg 322B. The shield winding Sh₂ is formed as two separated layers in the stack, including the shield layer Sh_{2A} and the shield layer Sh_{2B}. The shield layer Sh_{2A} is positioned over or above the primary winding P₂ in the stack, and the shield layer Sh_{2B} is positioned under or below the primary winding P₂ in the stack. The shield layers Sh_{2A} and Sh_{2B} are electrically coupled together in parallel form a single, double-layer turn around the second leg 322B. As shown in the electrical schematic of FIG. 6A, the shield winding Sh₂ forms a final turn of the primary winding P₂. Thus, the shield layers Sh_{2A} and Sh_{2B} are denoted as Sh_{2A} (P₂) and Sh_{2B} (P₂) in FIG. 6B.

Mutual magnetic flux passes through the first and second legs 322A and 322B of the magnetic “EI” core in the integrated transformer 300. Leakage flux passes through the auxiliary leg 322C of the magnetic “EI” core. Based on the unbalanced nature of the windings around the first leg 322A as compared to the second leg 322B and the leakage flux through the auxiliary leg 322C, the integrated transformer 300 exhibits a series inductance on the primary side of the integrated transformer 300. The series inductance can be relied upon as the resonant inductor Lᵣ.

The integrated transformer 300 shown in FIG. 6B exhibits less loss than (i.e., is more efficient than) the integrated transformer 120 shown in FIG. 4. The current density in the turns of the primary winding P₁ can be lower in the integrated transformer 300 than in the integrated transformer 120, particularly when implementing the integrated transformer 300 using the same number of metal layers and with the same footprint and volume as the integrated transformer 120. For example, the primary winding P₁ in the integrated transformer 300 can be implemented as two turns on each of two layers in a PCB, as shown in FIG. 6B. In the integrated transformer 120, on the other hand, one of the layers of the primary winding P₁ includes three turns (see FIG. 4), and the width of the traces for that layer of the primary winding P₁ are relatively more narrow, resulting in greater current density and winding loss particularly on the narrower traces.

The integrated transformer 300 shown in FIG. 6B can also exhibit less loss than the integrated transformer 200 shown in FIG. 5B. The current density in the turns of the primary winding P₂ can be lower in the integrated transformer 300 than in the integrated transformer 200, particularly when implementing the integrated transformer 300 using the same number of metal layers and with the same footprint and volume as the integrated transformer 200. For example, the primary winding P₂ in the integrated transformer 300 can be implemented as one turn on each of two layers in a PCB, as shown in FIG. 6B. In the integrated transformer 200, on the other hand, one of the layers of the primary winding P₂ includes two turns (see FIG. 5B), and the width of the traces for that layer of the primary winding P₂ are relatively more narrow, resulting in greater current density and winding loss particularly on the narrower traces.

The shield layers Sh_{2A} and Sh_{2B} enhance the EMI performance of the integrated transformers described herein. In one example, the shield layers Sh_{2A} and Sh_{2B} may enhance the EMI performance of integrated transformers by 20 dB or more at certain operating frequencies. The additional use of one or both of the shield layers Sh_{2A} and Sh_{2B} to extend the number of turns of the primary windings P₁ and P₂ can compromise the ability of the shield layers Sh_{2A} and Sh_{2B} to provide EMI rejection to some extent. However, the use of one or both of the shield layers Sh_{2A} and Sh_{2B} to extend the primary windings winding P₁ and P₂ only reduces the EMI performance of the integrated transformers by a relatively small amount, such by about 3 dB. At the same time, the use of the shield layers Sh_{2A} and Sh_{2B} to extend the primary windings P₁ and P₂ can offer significant reductions in winding loss and efficiency for the integrated transformers.

FIG. 7 illustrates an example integrated transformer 400 according to various aspects of the present disclosure. The integrated transformer 400 is an example implementation of an integrated transformer with resonant inductor and EMI shield according to the embodiments described herein. The integrated transformer 400 is shown as a representative example and is not drawn to any particular scale or size. The integrated transformer 400 includes a magnetic core, including a first core component 422 and a second core component 424, and a PCB metal layer winding stack 430 (also “winding stack 430”).

The magnetic core of the integrated transformer 400 can be embodied as a material of high magnetic permeability, such as a ferromagnetic material like iron, laminated silicon steel, laminated iron sheets, or other solid or laminated ferromagnetic ceramic, metal, metal alloy, or related material(s). The first core component 422 includes a first leg 422A, a second leg 422B, a center auxiliary leg 422C, a left auxiliary leg 422D, and a right auxiliary leg 422E. The second core component 424 includes a first leg 424A and a second leg 424B. The first core component 422 is similar to core component 222 of the integrated transformer 200 and the core component 322 of the integrated transformer 300. However, in addition to the center auxiliary leg 422C, the first core component 422 of the integrated transformer 400 also includes the left auxiliary leg 422D and the right auxiliary leg 422E.

The winding stack 430 includes the metal layers for the primary, secondary, and shield layers of the integrated transformer 400. The winding stack 430 can be implemented as six (6) metal layers of a PCB, as one example, although the winding stack 430 can include other numbers of metal layers in other cases. The winding stack 430 is illustrated without the dielectric insulating material of the PCB in FIG. 7. The dielectric insulating material provides electrical isolation between the metal layers in the winding stack 430, as would be understood in the field. A number of vias can be relied upon to electrically couple one or more of the metal layers together in the winding stack 430, as needed.

The winding stack 430 can be relied upon to implement any of the example primary, secondary, and shield configurations described herein. For example, the winding stack 430 can be relied upon to implement the electrical configuration of the primary windings P₁ and P₂, the shield windings Sh₁ and Sh₂, and the secondary windings S₁ and S₂ of the integrated transformer 10 shown in FIGS. 1 and 2, the integrated transformer 120 shown in FIGS. 3 and 4, the integrated transformer 200 shown in FIGS. 5A and 5B, the integrated transformer 300 shown in FIGS. 6A and 6B, and the other configurations described herein.

The magnetic core of the integrated transformer 400 offers certain advantages as compared to the magnetic cores in the integrated transformers 120, 200, and 300. Particularly, the addition of the left auxiliary leg 422D and the right auxiliary leg 422E provides better flux distribution. In the integrated transformers 200 and 300, for example, leakage flux tends to be concentrated in the auxiliary legs 222C and 322C, which can result in increased core loss. In the integrated transformer 400, leakage flux is further distributed among the center auxiliary leg 422C, the left auxiliary leg 422D, and the right auxiliary leg 422E. The increased distribution of the leakage flux can result in reduced core loss in the magnetic core of the integrated transformer 400 as compared to the integrated transformers 200 and 300, leading to increased efficiency when using the integrated transformer 400.

The magnetic core of the integrated transformer 400 can also vary as compared to that shown in FIG. 7. For example, the center auxiliary leg 422C, the left auxiliary leg 422D, and the right auxiliary leg 422E can be split between the first core component 422 and the second core component 424, similar to the way that the first and second legs of the magnetic core are split or shared between the core components. In that case, each of the center auxiliary leg 422C, the left auxiliary leg 422D, and the right auxiliary leg 422E would be shorter or smaller in the “Y” direction shown in FIG. 7, and the second core component 424 would include center, left, and right auxiliary legs having a dimension in the “Y” direction similar to that shown for the first leg 424A and the second leg 424B of the second core component 424.

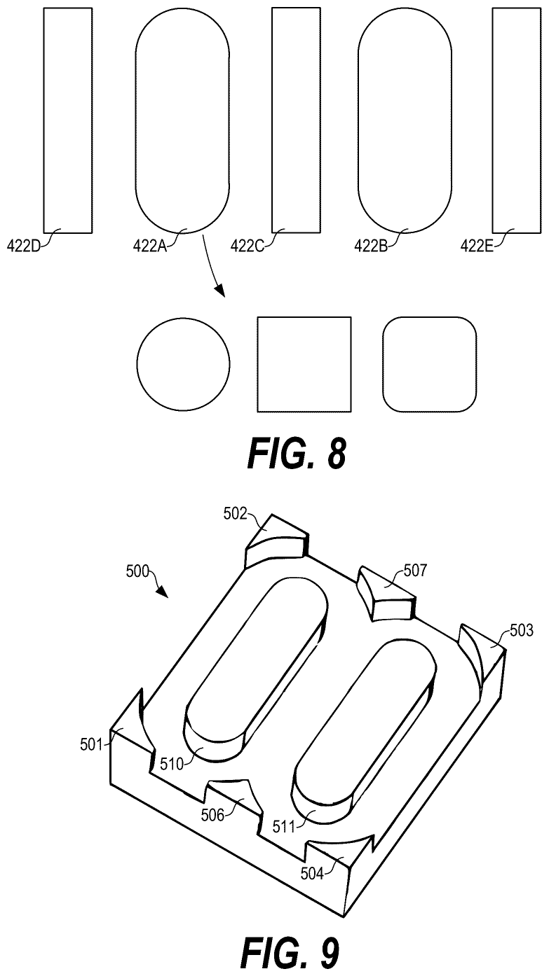

The magnetic core of the integrated transformer 400 can also vary in other ways. FIG. 8 illustrates other example profiles of core legs according to various aspects of the present disclosure. FIG. 8 illustrates an example plan (e.g., flat) view of the first leg 422A, the second leg 422B, the center auxiliary leg 422C, the left auxiliary leg 422D, and the right auxiliary leg 422E of the first core component 422. FIG. 8 is representative and not necessarily drawn to scale with the example of the first core component 422 shown in FIG. 7. As shown in FIG. 8, the center auxiliary leg 422C, the left auxiliary leg 422D, and the right auxiliary leg 422E are rectangular in profile shape. Additionally, the first leg 422A and the second leg 422B are rectangular with semi-circular ends in profile shape. However, the integrated transformer embodiments described herein can also be implemented with magnetic cores having other core leg profiles. For example, the legs of the magnetic cores can have circular profiles, square profiles, or square profiles with rounded corners, as shown in FIG. 8. The legs of the magnetic cores are not limited to those shapes, and other profile shapes can be relied upon. Additionally, the auxiliary legs of the magnetic cores can have circular profiles, square profiles, or square profiles with rounded corners, as shown in FIG. 8. The auxiliary legs of the magnetic cores are not limited to those shapes, and other profile shapes can be relied upon.

FIG. 9 illustrates another example magnetic core component 500 according to various aspects of the present disclosure. The magnetic core component 500 includes corner auxiliary legs 501-504 and side edge auxiliary legs 506 and 507. The magnetic core component 500 also includes a first leg 510 and a second leg 511. Two core components similar to the magnetic core component 500 can form the magnetic core of an integrated transformer according to the embodiments described herein. The magnetic core component 500 provides an example in which auxiliary legs can be positioned in a different way to distribute leakage flux. The corner auxiliary legs 501-504 are positioned at the corners of the magnetic core component 500 and have a triangular profile with two straight sides adjoined at a right angle and a semi-circular side. The side edge auxiliary legs 506 and 507 are positioned at opposite sides of the magnetic core component 500, between the first leg 510 and the second leg 511, and have a triangular profile with two semi-circular sides and a straight side.

Overall, the use of additional auxiliary legs positioned at the sides, the corners, along the peripheral sides, or at other locations around the legs around which the primary, secondary, and shield windings extend can provide better distribution of leakage flux in the integrated transformers described herein. Leakage flux can be distributed among the additional auxiliary legs, and the increased distribution of the leakage flux can result in reduced core loss as compared to magnetic cores with only a single auxiliary leg. Other examples of magnetic cores are also described below.

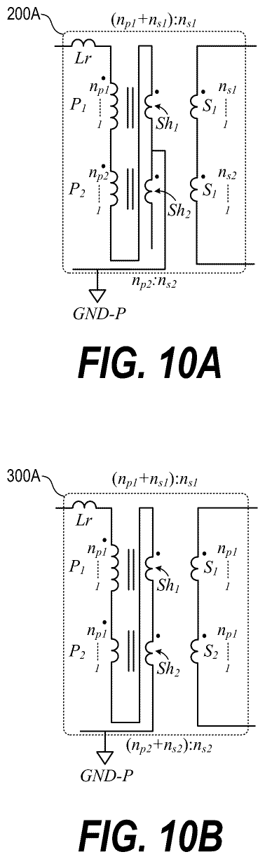

FIG. 10A illustrates another example integrated transformer 200A according to various aspects of the present disclosure. The integrated transformer 200A is similar to the integrated transformer 200 shown in FIG. 5A, but it is extended or scaled for use with other numbers of primary, secondary, and shield turns. In the integrated transformer 200A, the shield winding Sh₁ is used as an extension of the primary winding P₁. The integrated transformer 200A can include nₚ₁ turns of the primary winding P₁, nₚ₂ turns of the primary winding P₂, nₛ₁ turns of the secondary winding S₁, and nₛ₂ turns of the secondary winding S₂. The shield winding Sh₁ has the same number of turns as the secondary winding S₁, and the shield winding She has the same number of turns as the secondary winding S₂.

The first transformer in the integrated transformer 200A is an (nₚ₁+nₛ₁):nₛ₁ transformer. Particularly, the primary winding P₁ includes nₚ₁ turns, the shield winding Sh₁ includes an additional nₛ₁ (i.e., because the turns of Sh₁ are the same as the turns of S₁) of the primary winding P₁, and the secondary winding S₁ includes nₛ₁ turns. The second transformer in the integrated transformer 200A is an nₚ₂:nₛ₂ transformer. Particularly, the primary winding P₂ includes nₚ₂ turns and the secondary winding S₂ includes nₛ₂ turns.

The number nₚ₁ of turns of the primary winding P₁, the number of turns nₚ₂ of the primary winding P₂, the number of turns nₛ₁ of the secondary winding S₁, and the number of turns nₛ₂ turns of the secondary winding S₂ can vary among the embodiments. In any case, the turns ratio of the first transformer (e.g., (nₚ₁+nₛ₁):nₛ₁) can be different than the turns ratio of the second transformer (e.g., nₚ₂:nₛ₂) to create flux leakage and the resonant inductor of the integrated transformer 200A.

FIG. 10B illustrates another example integrated transformer 300A according to various aspects of the present disclosure. The integrated transformer 300A is similar to the integrated transformer 300 shown in FIG. 6A, but it is extended or scaled for use with other numbers of primary, secondary, and shield turns. In the integrated transformer 300A, the shield winding Sh₁ is used as an extension of the primary winding P₁. The shield winding Sh₂ is also used as an extension of the primary winding P₁2 The integrated transformer 300A can include nₚ₁ turns of the primary winding P₁, nₚ₂ turns of the primary winding P₂, nₛ₁ turns of the secondary winding S₁, and nₛ₂ turns of the secondary winding S₂. The shield winding Sh₁ has the same number of turns as the secondary winding S₁, and the shield winding Sh₂ has the same number of turns as the secondary winding S₂.

The first transformer in the integrated transformer 300A is an (nₚ₁+nₛ₁):nₛ₁ transformer. Particularly, the primary winding P₁ includes nₚ₁ turns, the shield winding Sh₁ includes an additional nₛ₁ (i.e., because the turns of Sh₁ are the same as the turns of S₁) of the primary winding P₁, and the secondary winding S₁ includes nₛ₁ turns. The second transformer in the integrated transformer 200A is an (nₚ₂+nₛ₂):nₛ₂ transformer. Particularly, the primary winding P₂ includes nₚ₂ turns, the shield winding Sh₂ includes an additional nₛ₂ (i.e., because the turns of Sh₂ are the same as the turns of S₂) of the primary winding P₂, and the secondary winding S₂ includes nₛ₂ turns.

The number nₚ₁ of turns of the primary winding P₁, the number of turns nₚ₂ of the primary winding P₂, the number of turns nisi of the secondary winding S₁, and the number of turns nₛ₂ turns of the secondary winding S₂ can vary among the embodiments. In any case, the turns ratio of the first transformer (e.g., (nₚ₁+nₛ₁):nₛ₁) can be different than the turns ratio of the second transformer (e.g., (nₚ₂+nₛ₂):nₛ₂) to create flux leakage and the resonant inductor of the integrated transformer 300A.

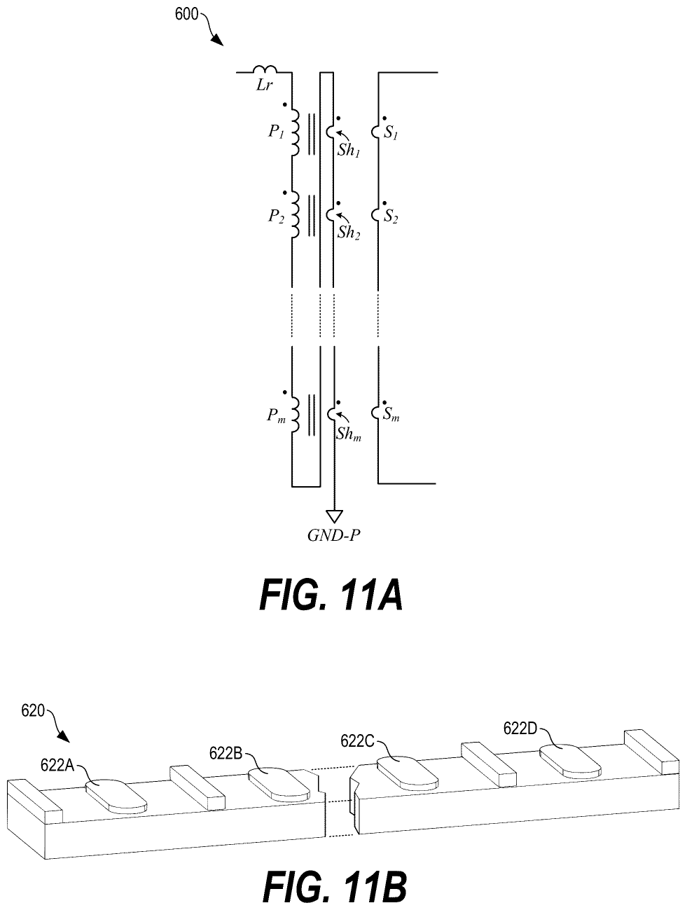

The integrated transformers described herein can also be extended to include additional transformers or transformer legs, in series or in parallel configurations. FIG. 11A illustrates another example integrated transformer 600 including additional series-connected transformer legs according to various aspects of the present disclosure. The integrated transformer 600 can be used in place of the integrated transformer 20 of the power converter 10 shown in FIG. 1, in place of the integrated transformer 120 of the power converter 100 shown in FIG. 3, or in other types of resonant power converters. The integrated transformer 600 includes a magnetic core (see FIG. 11B), primary windings P₁-Pₘ, shield windings Sh₁-Shₘ, and secondary windings S₁-Sₘ. The integrated transformer 600 includes m transformers in a series-connected arrangement. A first transformer is formed from the primary winding P₁, the shield winding Sh₁, and the secondary winding S₁. A second transformer is formed from the primary winding P₂, the shield winding Sh₂, and the secondary winding S₂. An m-th transformer is formed from the primary winding Pₘ, the shield winding Shₘ, and the secondary winding Sₘ.

FIG. 11B illustrates an example magnetic core component 620 for the integrated transformer 600 shown in FIG. 11A. The magnetic core component 620 is illustrated as a representative example and can be extended to include any number of legs, as needed, based on the number of transformers and transformer units in the integrated transformer 600 shown in FIG. 11A. The integrated transformer 600 can include a magnetic core formed of two of the magnetic core components 620 shown in FIG. 11B. The magnetic core component 620 includes legs 622A-622D (e.g., m legs corresponding to the m transformers of the integrated transformer 600). The primary winding P₁, the shield winding Sh₁, and the secondary winding S₁ for the first transformer shown in FIG. 11A can be wound around the leg 622A. The primary winding P₂, the shield winding Sh₂, and the secondary winding S₂ for the second transformer shown in FIG. 11A can be wound around the leg 622B. The primary winding Pₘ, the shield winding Shₘ, and the secondary winding Sₘ for the m-th transformer shown in FIG. 11A can be wound around the leg 622D.

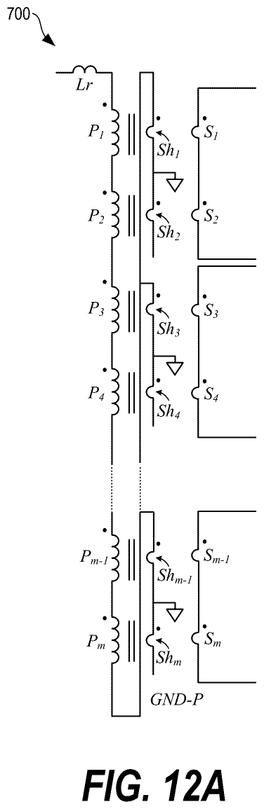

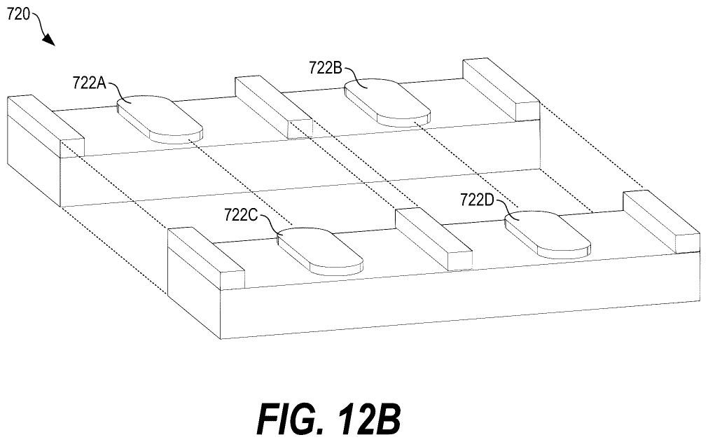

In other examples, FIG. 12A illustrates another example integrated transformer 700 including parallelized transformer legs according to various aspects of the present disclosure. The integrated transformer 700 can be used in place of the integrated transformer 20 of the power converter 10 shown in FIG. 1, in place of the integrated transformer 120 of the power converter 100 shown in FIG. 3, or in other types of resonant power converters. The integrated transformer 700 is similar to the integrated transformer 200 shown in FIG. 5A, but it has been extended to include additional transformer units.

The integrated transformer 700 includes a magnetic core (see FIG. 12B), primary windings P₁-Pₘ, shield windings Sh₁-Shₘ, and secondary windings S₁-Sₘ. The integrated transformer 700 includes m transformers, arranged in transformer units of two transformers each, with each transformer unit being parallel-connected with each other transformer unit. A first transformer is formed from the primary winding P₁, the shield winding Sh₁, and the secondary winding S₁. A second transformer is formed from the primary winding P₂ and the secondary winding S₂, with the shield winding Sh₂ positioned between them. A third transformer is formed from the primary winding P₃, the shield winding Sh₃, and the secondary winding S₃. A fourth transformer is formed from the primary winding P₄ and the secondary winding S₄, with the shield winding Sh₄ positioned between them. An m−1-th transformer is formed from the primary winding Pₘ₋₁, the shield winding Shₘ₋₁, and the secondary winding Sₘ₋₁. An m-th transformer is formed from the primary winding Pₘ and the secondary winding Sₘ, with the shield winding Shₘ positioned between them.

FIG. 12B illustrates an example magnetic core component 720 for the integrated transformer 700 shown in FIG. 12A. The magnetic core component 720 is illustrated as a representative example and can be extended to include any number of legs, as needed, based on the number of transformers and transformer units in the integrated transformer 700 shown in FIG. 12A. The integrated transformer 700 can include a magnetic core formed of two of the magnetic core components 720 shown in FIG. 12B. The magnetic core component 720 includes legs 722A-722D. The primary winding P₁, the shield winding Sh₁, and the secondary winding S₁ for the first transformer shown in FIG. 12A can be wound around the leg 622A. The primary winding P₂, the shield winding Sh₂, and the secondary winding S₂ for the second transformer shown in FIG. 12A can be wound around the leg 622B. The primary winding Pₘ₋₁, the shield winding Shₘ₋₁, and the secondary winding Sₘ₋₁ for the m−1-th transformer shown in FIG. 12A can be wound around the leg 622C. The primary winding Pₘ, the shield winding Shₘ, and the secondary winding Sₘ for the m-th transformer shown in FIG. 12A can be wound around the leg 622D.

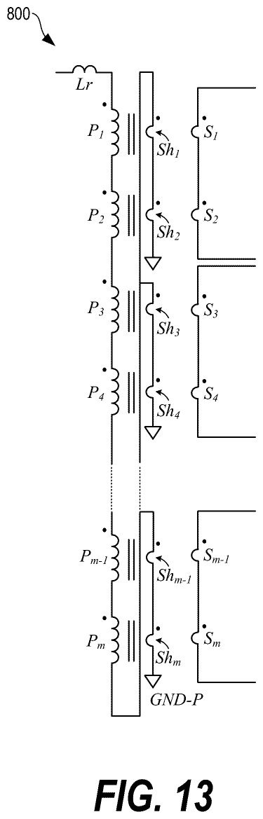

FIG. 13 illustrates another example integrated transformer 800 including parallelized transformer legs according to various aspects of the present disclosure. The integrated transformer 800 can be used in place of the integrated transformer 20 of the power converter 10 shown in FIG. 1, in place of the integrated transformer 120 of the power converter 100 shown in FIG. 3, or in other types of resonant power converters. The integrated transformer 800 is similar to the integrated transformer 300 shown in FIG. 6A, but it has been extended to include additional transformer units.

The integrated transformer 800 includes a magnetic core (see FIG. 12B), primary windings P₁-Pₘ, shield windings Sh₁-Shₘ, and secondary windings S₁-Sₘ. The integrated transformer 800 includes m transformers, arranged in transformer units of two transformers each, with each transformer unit being parallel-connected with each other transformer unit. A first transformer is formed from the primary winding P₁, the shield winding Sh₁, and the secondary winding S₁. A second transformer is formed from the primary winding P₂, the shield winding Sh₁, and the secondary winding S₂. A third transformer is formed from the primary winding P₃, the shield winding Sh₃, and the secondary winding S₃. A fourth transformer is formed from the primary winding P₄, the shield winding Sh₄, and the secondary winding S₄. An m−1-th transformer is formed from the primary winding Pₘ₋₁, the shield winding Shₘ₋₁, and the secondary winding Sₘ₋₁. An m-th transformer is formed from the primary winding Pₘ, the shield winding Shₘ, and the secondary winding Sₘ. In other examples, the number of primary, shield, and secondary windings of the integrated transformers shown in FIGS. 11A, 12A, and 13 can be extended to use with an arbitrary number of winding turns, as described in connection with FIGS. 10A and 10B.

The controllers described herein, including the controller 12, can be embodied as processing circuitry, including memory, configured to control the operation of the power converters, with or without feedback. The controllers can be embodied as any suitable type of controller, such as a proportional integral derivative (PID) controller, a proportional integral (PI) controller, or a multi-pole multi-zero controller, among others, to control the operations of the power converters. The controllers can be realized using a combination of processing circuitry and referenced as a single controller. It should be appreciated, however, that the controllers can be realized using a number of controllers, control circuits, drivers, and related circuitry, operating with or without feedback.

One or more microprocessors, microcontrollers, or DSPs can execute software to perform the control aspects of the embodiments described herein, such as the control aspects performed by the controller 12. Any software or program instructions can be embodied in or on any suitable type of non-transitory computer-readable medium for execution. Example computer-readable mediums include any suitable physical (i.e., non-transitory or non-signal) volatile and non-volatile, random and sequential access, read/write and read-only, media, such as hard disk, floppy disk, optical disk, magnetic, semiconductor (e.g., flash, magneto-resistive, etc.), and other memory devices. Further, any component described herein can be implemented and structured in a variety of ways. For example, one or more components can be implemented as a combination of discrete and integrated analog and digital components.

Terms such as “top,” “bottom,” “side,” “front,” “back,” “right,” and “left” are not intended to provide an absolute frame of reference. Rather, the terms are relative and are intended to identify certain features in relation to each other, as the orientation of structures described herein can vary. The terms “comprising,” “including,” “having,” and the like are synonymous, are used in an open-ended fashion, and do not exclude additional elements, features, acts, operations, and so forth. Also, the term “or” is used in its inclusive sense, and not in its exclusive sense, so that when used, for example, to connect a list of elements, the term “or” means one, some, or all of the elements in the list.

Combinatorial language, such as “at least one of X, Y, and Z” or “at least one of X, Y, or Z,” unless indicated otherwise, is used in general to identify one, a combination of any two, or all three (or more if a larger group is identified) thereof, such as X and only X, Y and only Y, and Z and only Z, the combinations of X and Y, X and Z, and Y and Z, and all of X, Y, and Z. Such combinatorial language is not generally intended to, and unless specified does not, identify or require at least one of X, at least one of Y, and at least one of Z to be included. The terms “about” and “substantially,” unless otherwise defined herein to be associated with a particular range, percentage, or related metric of deviation, account for at least some manufacturing tolerances between a theoretical design and manufactured product or assembly, such as the geometric dimensioning and tolerancing criteria described in the American Society of Mechanical Engineers (ASME®) Y14.5 and the related International Organization for Standardization (ISO®) standards. Such manufacturing tolerances are still contemplated, as one of ordinary skill in the art would appreciate, although “about,” “substantially,” or related terms are not expressly referenced, even in connection with the use of theoretical terms, such as the geometric “perpendicular,” “orthogonal,” “vertex,” “collinear,” “coplanar,” and other terms.

The above-described embodiments of the present disclosure are merely examples of implementations to provide a clear understanding of the principles of the present disclosure. Many variations and modifications can be made to the above-described embodiments without departing substantially from the spirit and principles of the disclosure. In addition, components and features described with respect to one embodiment can be included in another embodiment. All such modifications and variations are intended to be included herein within the scope of this disclosure.

What is claimed is:

1. A power converter, comprising:
a primary-side converter stage and a plurality of secondary-side converter stages; and
an integrated transformer and resonant inductor electrically coupled between the primary-side converter stage and the plurality of secondary-side converter stages, comprising:
a magnetic core comprising a first leg, an auxiliary leg, and a second leg;
a first transformer comprising a first primary winding, a first secondary winding, and a first shield winding on the first leg; and
a second transformer comprising a second primary winding, a second secondary winding, and a second shield winding on the second leg, wherein:
the first shield winding is electrically coupled in the integrated transformer to provide an extension of the first primary winding for the first transformer; and
an end of the first shield winding or the second shield winding is electrically coupled to a primary-side ground of the power converter.

2. The power converter according to claim 1, wherein:
the first shield winding and the second shield winding are electrically coupled in series at a center node between the first shield winding and the second shield winding; and
the first shield winding and the second shield winding are electrically coupled to the primary-side ground of the power converter at the center node between the first shield winding and the second shield winding.

3. The power converter according to claim 1, wherein:
the first shield winding and the second shield winding are electrically coupled in series at a center node between the first shield winding and the second shield winding; and
the first shield winding and the second shield winding are electrically coupled to the primary-side ground of the power converter at one end of the second shield winding apart from the center node between the first shield winding and the second shield winding.

4. The power converter according to claim 1, wherein:
the first primary winding and the second primary winding are electrically coupled in series at a center node between the first shield winding and the second shield winding;
one end of the second primary winding is electrically coupled in series with the first primary winding; and
another end of the second primary winding is electrically coupled to one end of the first shield winding apart from the center node between the first shield winding and the second shield winding.

5. The power converter according to claim 1, wherein:
the first primary winding and the second primary winding are electrically coupled in series at a center node between the first shield winding and the second shield winding;
one end of the second primary winding is electrically coupled in series with the first primary winding;
another end of the second primary winding is electrically coupled to one end of the first shield winding apart from the center node between the first shield winding and the second shield winding; and
the first shield winding and the second shield winding are electrically coupled to the primary-side ground of the power converter at the center node between the first shield winding and the second shield winding.

6. The power converter according to claim 1, wherein:
the first primary winding and the second primary winding are electrically coupled in series at a center node between the first shield winding and the second shield winding;
one end of the second primary winding is electrically coupled in series with the first primary winding;
another end of the second primary winding is electrically coupled to one end of the first shield winding apart from the center node between the first shield winding and the second shield winding; and
the first shield winding and the second shield winding are electrically coupled to the primary-side ground of the power converter at one end of the second shield winding apart from the center node between the first shield winding and the second shield winding.

7. The power converter according to claim 1, wherein the magnetic core further comprises a left auxiliary leg and right auxiliary leg for distribution of leakage flux and reduced core loss in the magnetic core.

8. The power converter according to claim 1, wherein:
the first transformer and the second transformer comprises a first transformer unit of the integrated transformer;
the magnetic core further comprises a third leg and a fourth leg;
the integrated transformer and resonant inductor further comprises a third transformer on the third leg and a fourth transformer on the fourth leg; and
the third transformer and the fourth transformer comprises a second transformer unit of the integrated transformer.

9. The power converter according to claim 8, wherein the first transformer unit and the second transformer unit are series-connected.

10. The power converter according to claim 8, wherein the first transformer unit and the second transformer unit are parallel-connected.

11. A power converter, comprising:
a primary-side converter stage and a plurality of secondary-side converter stages; and
an integrated transformer and resonant inductor electrically coupled between the primary-side converter stage and the plurality of secondary-side converter stages, comprising:
a magnetic core comprising a first leg, a second leg, and a plurality of auxiliary legs;
a first transformer comprising a first primary winding, a first secondary winding, and a first shield winding on the first leg; and
a second transformer comprising a second primary winding, a second secondary winding, and a second shield winding on the second leg, wherein:
the first shield winding is electrically coupled in the integrated transformer to provide an extension of the first primary winding for the first transformer;
an end of the first shield winding or the second shield winding is electrically coupled to a primary-side ground of the power converter; and
a first turns ratio between the first primary winding to the first secondary winding is different than a second turns ratio between the second primary winding to the second secondary winding.

12. The power converter according to claim 11, wherein:
the first shield winding and the second shield winding are electrically coupled in series at a center node between the first shield winding and the second shield winding; and
the first shield winding and the second shield winding are electrically coupled to the primary-side ground of the power converter at the center node between the first shield winding and the second shield winding.

13. The power converter according to claim 11, wherein:
the first shield winding and the second shield winding are electrically coupled in series at a center node between the first shield winding and the second shield winding; and
the first shield winding and the second shield winding are electrically coupled to the primary-side ground of the power converter at one end of the second shield winding apart from the center node between the first shield winding and the second shield winding.

14. The power converter according to claim 11, wherein the plurality of auxiliary legs distribute leakage flux in the magnetic core for reduced core loss.

15. An integrated transformer and resonant inductor for a power converter, comprising:
a magnetic core comprising a first leg, a second leg, and a plurality of auxiliary legs;
a first transformer comprising a first primary winding, a first secondary winding, and a first shield winding on the first leg; and
a second transformer comprising a second primary winding, a second secondary winding, and a second shield winding on the second leg, wherein:
the first shield winding is electrically coupled in the integrated transformer to provide an extension of the first primary winding for the first transformer; and
an end of the first shield winding or the second shield winding is electrically coupled to a primary-side ground of the power converter.

16. The integrated transformer and resonant inductor according to claim 15, wherein:
the first shield winding and the second shield winding are electrically coupled in series at a center node between the first shield winding and the second shield winding; and
the first shield winding and the second shield winding are electrically coupled to the primary-side ground of the power converter at the center node between the first shield winding and the second shield winding.

17. The integrated transformer and resonant inductor according to claim 15, wherein:
the first shield winding and the second shield winding are electrically coupled in series at a center node between the first shield winding and the second shield winding; and
the first shield winding and the second shield winding are electrically coupled to the primary-side ground of the power converter at one end of the second shield winding apart from the center node between the first shield winding and the second shield winding.

18. The integrated transformer and resonant inductor according to claim 15, wherein:
the first primary winding and the second primary winding are electrically coupled in series at a center node between the first shield winding and the second shield winding;
one end of the second primary winding is electrically coupled in series with the first primary winding; and
another end of the second primary winding is electrically coupled to one end of the first shield winding apart from the center node between the first shield winding and the second shield winding.

19. The integrated transformer and resonant inductor according to claim 15, wherein:
the first primary winding and the second primary winding are electrically coupled in series at a center node between the first shield winding and the second shield winding;
one end of the second primary winding is electrically coupled in series with the first primary winding;
another end of the second primary winding is electrically coupled to one end of the first shield winding apart from the center node between the first shield winding and the second shield winding; and
the first shield winding and the second shield winding are electrically coupled to the primary-side ground of the power converter at the center node between the first shield winding and the second shield winding.

20. The integrated transformer and resonant inductor according to claim 15, wherein:
the first primary winding and the second primary winding are electrically coupled in series at a center node between the first shield winding and the second shield winding;
one end of the second primary winding is electrically coupled in series with the first primary winding;
another end of the second primary winding is electrically coupled to one end of the first shield winding apart from the center node between the first shield winding and the second shield winding; and
the first shield winding and the second shield winding are electrically coupled to the primary-side ground of the power converter at one end of the second shield winding apart from the center node between the first shield winding and the second shield winding.
